(19) United States
(12) Patent Application Publication
(10) Pub. No.: US 2025/0125545 A1
(43) Pub. Date: Apr. 17, 2025

(54) COAXIAL CABLE AND MULTI-CORE CABLE

(71) Applicant: SUMITOMO ELECTRIC INDUSTRIES, LTD., Osaka (JP)

(72) Inventor: Takaaki OKAMOTO, Tochigi (JP)

(21) Appl. No.: 18/764,721

(22) Filed: Jul. 5, 2024

(30) Foreign Application Priority Data
Oct. 12, 2023 (JP) 2023-177061

(51) Int. Cl. H01R 9/05; H01R 13/6592; H01R 24/56

(52) U.S. Cl. CPC H01R 9/0506; H01R 13/6592; H01R 24/56

(57) ABSTRACT

A coaxial cable includes a central conductor including a plurality of twisted conductor element wires, an insulator disposed outside the central conductor, a shield layer disposed outside the insulator, and a jacket disposed outside the shield layer. The shield layer includes a first shield layer and a second shield layer in an order from a position closest to the central conductor. The first shield layer includes a plurality of longitudinally lapped metal wires, and the second shield layer includes a metal tape disposed outside the first shield layer. An outer diameter of the central conductor is 0.2 mm or more and 0.4 mm or less, and a twist pitch of the conductor element wires of the central conductor is 6 times or more and 10 times or less the outer diameter of the central conductor.

### CROSS-REFERENCE TO RELATED APPLICATIONS

This application is based upon and claims priority to Japanese Patent Application No. 2023-177061, filed on Oct. 12, 2023, the entire contents of which are incorporated herein by reference.

### TECHNICAL FIELD

The present disclosure relates to coaxial cables and multi-core cables.

### BACKGROUND

As an example, Japanese Laid-Open Patent Publication No. 2022-003613 proposes a coaxial cable having a conductor, an insulator covering a periphery of the conductor, a shield layer including a longitudinally lapped (or laterally wound) shield formed by a plurality of spirally wound metal element wires so as to cover a periphery of the insulator, and a sheath covering a periphery of the shield layer. Recesses into which the plurality of metal element wires fit are formed in a surface of a portion of the insulator in contact with the plurality of metal element wires. Portions of the shield layer in contact with the insulator in a circumferential direction of the plurality of metal element wires fit into the recesses. Adjacent element wires among the plurality of metal element wires, adjacent to each other in the circumferential direction of the shield layer, make surface contact with each other.

Conventionally, the coaxial cable having the shield layer is used in various applications.

In the conventional coaxial cable, a phenomenon called suck-out may be generated. When the suck-out is generated, a rapid attenuation is generated in a predetermined frequency range.

### SUMMARY

One object according to one aspect of the present disclosure is to provide a coaxial cable which can reduce the suck-out.

A coaxial cable according to one aspect of the present disclosure includes a central conductor including a plurality of twisted conductor element wires; an insulator disposed outside the central conductor; a shield layer disposed outside the insulator; and a jacket disposed outside the shield layer, wherein the shield layer includes a first shield layer and a second shield layer in an order from a position closest to the central conductor, the first shield layer includes a plurality of longitudinally lapped metal wires, the second shield layer includes a metal tape disposed outside the first shield layer, an outer diameter of the central conductor is 0.2 mm or more and 0.4 mm or less, and a twist pitch of the conductor element wires of the central conductor is 6 times or more and 10 times or less the outer diameter of the central conductor.

A multi-core cable according to another aspect of the present disclosure includes a core including a plurality of sheathed electric wires including the coaxial cable described above; and an outer sheath disposed outside the core.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a cross sectional view of a coaxial cable according to one aspect of the present disclosure, taken along a surface perpendicular to a longitudinal direction;

FIG. 2 is a cross sectional view of a metal tape taken along a surface perpendicular to the longitudinal direction thereof;

FIG. 3 is a cross sectional view of a multi-core cable according to one aspect of the present disclosure, taken along a surface perpendicular to the longitudinal direction;

FIG. 4 is a diagram illustrating an evaluation result of an attenuation of a coaxial cable manufactured in an experimental example Exp-1; and

FIG. 5 is a diagram illustrating the evaluation result of the attenuation of the coaxial cable manufactured in an experimental example Exp-2.

### DETAILED DESCRIPTION

A description will hereinafter be given of embodiments of the present disclosure.

### Description of Embodiments of Present Disclosure

First, embodiments of the present disclosure will be described with reference to the drawings. In the following description, the same or corresponding elements are designated by the same reference numerals, and a redundant description thereof will be omitted.

(1) A coaxial cable according to one aspect of the present disclosure includes a central conductor including a plurality of twisted conductor element wires; an insulator disposed outside the central conductor; a shield layer disposed outside the insulator; and a jacket disposed outside the shield layer, wherein the shield layer includes a first shield layer and a second shield layer in an order from a position closest to the central conductor, the first shield layer includes a plurality of longitudinally lapped metal wires, the second shield layer includes a metal tape disposed outside the first shield layer, an outer diameter of the central conductor is 0.2 mm or more and 0.4 mm or less, and a twist pitch of the conductor element wires of the central conductor is 6 times or more and 10 times or less the outer diameter of the central conductor.

The coaxial cable according to one aspect of the present disclosure includes the first shield layer and the second shield layer as the shield layer, and thus, it is possible to particularly prevent a signal leakage to the outside and a radio wave intrusion from the outside.

By setting the twist pitch of the conductor element wires of the central conductor to be 6 times or more and 10 times or less the outer diameter of the central conductor, frequencies at which a suck-out is generated may be set to a frequency range higher than 20 GHz. For this reason, it is possible to reduce the suck-out in the frequency range of signals transmitted by the coaxial cable according to one aspect of the present disclosure.

(2) A multi-core cable according to one aspect of the present disclosure includes a core including a plurality of sheathed electric wires including the coaxial cable according to (1) described above; and an outer sheath disposed outside the core.

The multi-core cable according to one aspect of the present disclosure includes the coaxial cable according to one aspect of the present disclosure, and can thus reduce the suck-out.

### Details of Embodiments of Present Disclosure

Specific examples of the coaxial cable and the multi-core cable according to one embodiment of the present disclosure (hereinafter referred to as the “present embodiment”) will be described below with reference to the drawings. The present invention is not limited to these specific examples, and may be defined by the scope of the claims, and is intended to include all variations and modifications within the meaning and scope equivalent to the scope of the claims.

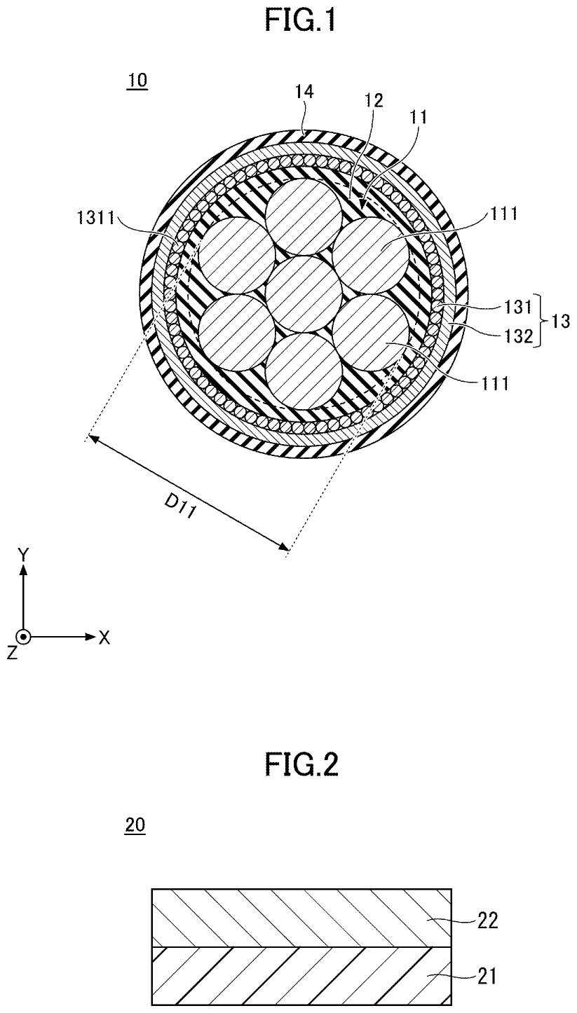

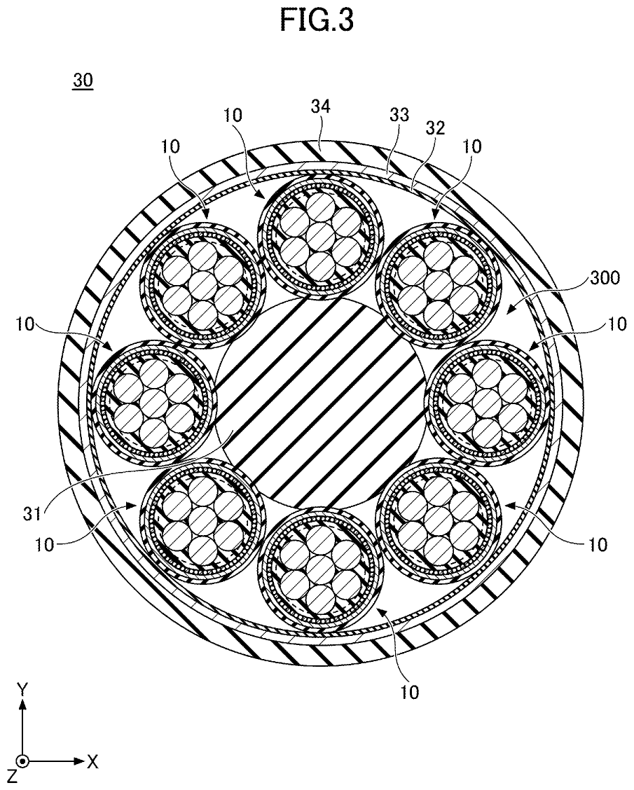

FIG. 1, FIG. 2, and FIG. 3 schematically illustrate configurations of the coaxial cable, the metal tape, and the multi-core cable for explaining an arrangement or the like of each member, and the size, shape, or the like of each member are not drawn to scale.

### Coaxial Cable

FIG. 1 is a cross sectional view of a coaxial cable 10 according to the present embodiment along a surface perpendicular to a longitudinal direction of the coaxial cable 10. An XYZ coordinate system is used in FIG. 1 for the sake of convenience. In FIG. 1, a Z-axis perpendicular to a paper surface (plane of FIG. 1) is an axis along the longitudinal direction of the coaxial cable 10 and a central conductor 11, and an XY-plane is a plane perpendicular to the longitudinal direction of the coaxial cable 10 and the central conductor 11.

As illustrated in FIG. 1, the coaxial cable 10 according to the present embodiment includes the central conductor 11, an insulator 12 disposed outside the central conductor 11, a shield layer 13 disposed outside the insulator 12, and a jacket 14 disposed outside the shield layer 13.

Hereinafter, each member included in the coaxial cable 10 according to the present embodiment will be described.

### (1) Members of Coaxial Cable

### (1-1) Central Conductor and Conductor Element Wire

The central conductor 11 has a configuration including a plurality of twisted conductor element wires 111. That is, the central conductor 11 may be a stranded conductor.

A material used for the conductor element wires 111 is not particularly limited, and for example, one or more kinds of conductor materials selected from a copper alloy, copper, silver-plated annealed copper, and tin-plated annealed copper may be used for the conductor element wires 111. Annealed copper may be suitably used as the copper.

Although FIG. 1 illustrates an example in which seven conductor element wires 111 are twisted together to form the central conductor 11, the number of conductor element wires 111 forming the central conductor 11 is not particularly limited. The number of the conductor element wires 111 forming the central conductor 11 may be set to any number according to an outer diameter D11, a cross sectional area, or the like required of the central conductor 11.

The present inventor conducted studies on coaxial cables which can reduce the suck-out. In the present specification, the coaxial cable having a reduced suck-out refers to a coaxial cable having generation of the suck-out reduced in a frequency range of 20 GHz or lower.

As a result of the studies conducted, the present inventor conceived that the generation of the suck-out can be reduced by configuring the central conductor 11 so that the twist pitch of the conductor element wires 111 of the central conductor 11 is a predetermined number multiple with respect to the outer diameter D11 of the central conductor 11, and completed the present invention.

In the coaxial cable 10 according to the present embodiment, the twist pitch of the conductor element wires 111 of the central conductor 11 may be set to be 6 times or more and 10 times or less the outer diameter D11 of the central conductor 11.

By setting the twist pitch of the conductor element wires 111 of the central conductor 11 to 6 times or more and 10 times or less the outer diameter D11 of the central conductor 11, the frequencies at which the suck-out is generated may be set to a frequency range higher than 20 GHz. For this reason, the generation of the suck-out in the frequency range of the signals transmitted by the coaxial cable 10 can be reduced.

The twist pitch of the conductor element wires 111 of the central conductor 11 may be 6 times or more and 8 times or less the outer diameter D11 of the central conductor 11.

The outer diameter D11 of the central conductor 11 is not particularly limited, and may be 0.2 mm or more and 0.4 mm or less, for example.

### (1-2) Insulator

A material used for the insulator 12 is not particularly limited, and may include a resin material, for example.

The resin material may be selected from one or more kinds of resins including fluororesins, polyester resins, polyolefin resins, polyvinyl chloride, polymethylpentene, or the like, for example. The fluororesins include polytetrafluoroethylene (PTFE), tetrafluoroethylene-perfluoroalkyl vinyl ether copolymer (PFA), tetrafluoroethylene-hexafluoropropylene copolymer (FEP), ethylene-tetrafluoroethylene copolymer (ETFE), or the like. The polyester resins include polyethylene terephthalate (PET) or the like. The polyolefin resins include polyethylene, polypropylene, ethylene-vinyl acetate copolymer (EVA), or the like. The resin material included in the insulator may or may not be crosslinked.

The insulator 12 may be composed solely of the resin material. However, the insulator 12 may include one or more additives selected from a flame retardant, a flame retardant assistant, an antioxidant, a lubricant, a coloring agent, a reflection-imparting agent, a masking agent, a processing stabilizer, a plasticizer, or the like in addition to the resin material.

### (1-3) Shield Layer

The coaxial cable 10 according to the present embodiment may include, as the shield layer 13, a first shield layer 131 and a second shield layer 132 in this order from a position closest to the central conductor 11.

Because the coaxial cable 10 according to the present embodiment includes the first shield layer 131 and the second shield layer 132 as the shield layer 13, it is possible to particularly reduce a signal leakage to the outside and a radio wave intrusion from the outside.

Each shield layer will be described in the following.

### (First Shield Layer)

The first shield layer 131 is a layer of longitudinally lapped (or laterally wound) metal wires 1311, that is, a layer having the plurality of metal wires 1311 that are spirally wound in a state where the plurality of metal wires 1311 are arranged in parallel and adjacent metal wires 1311 are in contiguous contact with each other.

By forming the first shield layer 131 as the layer of longitudinally lapped metal wires 1311, the coaxial cable 10 can be made thin, a flexibility of the coaxial cable 10 can be increased, and the coaxial cable 10 can be made easily bendable. Further, by forming the first shield layer 131 as the layer of longitudinally lapped metal wires 1311, it is possible to reduce a cost of the coaxial cable 10.

A material used for the metal wires 1311 is not particularly limited, and for example, metal materials such as copper, copper alloy, aluminum, aluminum alloy, or the like, materials having a surface thereof plated with such metal materials, or the like may be used for the metal wires 1311. A tin-plated annealed copper or the like may be used as the metal material having the surface thereof plated. Annealed copper may be suitably used as the copper.

### (Second Shield Layer)

The second shield layer 132 is a layer of a metal tape disposed outside the first shield layer 131. The second shield layer 132 may have a configuration in which the metal tape is spirally wound around a surface of the first shield layer 131.

A configuration example of a metal tape 20 that may be used for the second shield layer 132 will be described with reference to FIG. 2. FIG. 2 is a cross sectional view of the metal tape 20 along a surface perpendicular to the longitudinal direction of the metal tape 20.

As illustrated in FIG. 2, the metal tape 20 may include a resin layer 21 and a metal layer 22. The metal tape 20 has a laminate structure in which the resin layer 21 and the metal layer 22 are laminated.

Examples of the resin included in the resin layer 21 include one or more kinds of resins selected from polyester resins such as polyethylene terephthalate (PET) or the like, polyolefin resins such as polypropylene (PP) or the like, and vinyl resins such as polyvinyl chloride (PVC) or the like. The resin layer 21 may include an additive or the like, in addition to the various kinds of resins.

The material used for the metal layer 22 is not particularly limited, and for example, one or more kinds of metal materials selected from copper, copper alloy, aluminum, aluminum alloy, or the like may be used for the metal layer 22. The metal layer 22 may be composed of a single metal species or may be composed by laminating metal layers of two or more metal species. In addition, a material other than metal, such as a protective film including an organic material, may be disposed on a surface of the metal layer 22.

The metal layer 22 may be a vapor deposition film or a plating film.

### (1-4) Jacket

The jacket 14 may be disposed outside the shield layer 13.

A material used for the jacket 14 is not particularly limited, and may include a resin material, for example. Examples of the resin material include one or more kinds of resins selected from polyester resins such as polyethylene terephthalate (PET) or the like, polyolefin resins such as polyethylene or the like, polyvinyl chloride (PVC), and fluororesins such as FEP, PFA, or the like.

The jacket 14 may include various kinds of additives such as a flame retardant or the like, in addition to the resin material.

The resin material of the jacket 14 may or may not be crosslinked.

The jacket 14 may be formed by spirally winding a resin tape including the resin material on the surface of the shield layer 13, for example.

### Multi-core Cable

FIG. 3 is a cross sectional view illustrating a configuration example of the multi-core cable according to the present embodiment along a surface perpendicular to the longitudinal direction of the multi-core cable. A direction along the Z-axis from the paper surface in FIG. 3 corresponds to the longitudinal direction of the multi-core cable 30 and the core 300. The XY-plane is a cross section perpendicular to the longitudinal direction of the multi-core cable 30 and the core 300.

As illustrated in FIG. 3, the multi-core cable 30 according to the present embodiment includes the core 300 formed by twisting together a plurality of sheathed electric wires (or covered electric wires) including the coaxial cables 10, and an outer sheath 34 disposed outside the core 300.

Because the multi-core cable 30 according to the present embodiment includes the coaxial cables 10 according to one aspect of the present disclosure, it is possible to reduce the suck-out.

Each member included in the multi-core cable according to the present embodiment will be described.

### (1) Core

The core 300 includes a plurality of sheathed electric wires including the coaxial cables 10 according to one aspect of the present disclosure.

In the multi-core cable 30 illustrated in FIG. 3, the core 300 includes eight coaxial cables 10 according to one aspect of the present disclosure, but the present invention is not limited to such a configuration.

The configuration and the number of the sheathed electric wires included in the core 300 are not particularly limited, and may be selected according to the performance or the like required of the multi-core cable 30.

The core 300 may include, as the sheathed electric wires, an electric wire including the central conductor 11 and the insulator 12 disposed outside the central conductor 11, in addition to the coaxial cables 10. The core 300 may include a drain wire composed solely of a conductor, in addition to the sheathed electric wires.

The sheathed electric wire of the multi-core cable 30 may be a twisted pair cable having two electric wires twisted together.

The arrangement of the sheathed electric wires of the core 300 is not particularly limited, and for example, the sheathed electric wires may be arranged so as to form a single layer or a plurality of layers from a center in a cross section perpendicular to the longitudinal direction of the core 300.

In the multi-core cable 30 illustrated in FIG. 3, the core 300 is arranged so that the coaxial cables 10, which are the sheathed electric wires, form a single layer, and is twisted together with the coaxial cables 10.

### (2) Outer Sheath

The outer sheath 34 may be disposed outside the core 300.

A material used for the outer sheath 34 is not particularly limited, and the outer sheath 34 may include a resin material. Examples of the resin material include polyolefins such as polyethylene or the like, polyvinyl chloride (PVC), thermoplastic elastomer (TPE), or the like.

The outer sheath 34 may include various kinds of additives, such as a flame retardant or the like, in addition to the resin material.

The material used for the outer sheath 34 may or may not be crosslinked.

Because the multi-core cable 30 has the outer sheath 34, it is possible to protect the sheathed electric wires or the like arranged inside.

The multi-core cable 30 may include a member other than the core 300 and the outer sheath 34.

### (3) Outer Shield Layer

An outer shield layer 33 may be disposed between the core 300 and the outer sheath 34.

Because the multi-core cable 30 includes the outer shield layer 33, it is possible to reduce noise from being superimposed on (or mixed into) signals propagating through the sheathed electric wires. Moreover, it is possible to reduce the effects of the noise on external devices by reducing the noise.

The outer shield layer 33 may include a conductive material.

For example, the outer shield layer 33 may have a configuration in which a conductive tape including a conductive layer is spirally wound around the core 300.

The conductive tape may include a base material, and a conductive layer disposed on at least one of an upper surface and a lower surface of the base material. The conductive tape may have the conductive layer disposed on both the upper surface and the lower surface of the base material. The conductive tape may have a configuration that includes no base material, and may be composed solely of the conductive layer.

A material used for the conductive layer is not particularly limited, but preferably includes a metal, and may be a metal foil, for example. In a case where the conductive layer includes a metal, the metal material is not particularly limited, and for example, copper, copper alloy, aluminum, aluminum alloy, or the like may be used for the metal material.

A material used for the base material is not particularly limited, but is preferably an insulating material, such as an organic polymer material, a nonwoven fabric, or the like. Examples of the organic polymer material include polyester resins such as polyethylene terephthalate (PET) or the like, polyolefin resins such as polypropylene or the like, vinyl resins such as polyvinyl chloride or the like, or the like. The base material may include an insulating material, or may be formed solely of an insulating material.

As described above, in the case where the conductive tape is wound to form the outer shield layer 33, a winding direction of the conductive tape may be arbitrarily selected, and may be the same direction as the twisting direction of the core 300 or may be a direction different from the twisting direction of the core 300.

The outer shield layer 33 may include metal element wires. In this case, the outer shield layer 33 may have a configuration in which the metal element wires are longitudinally lapped or braided. A material used for the metal element wires may be copper, aluminum, copper alloy, or the like. A surface of the metal element wire may be plated with silver or tin. For this reason, a silver-plated copper alloy, a tin-plated copper alloy, or the like may be used for the metal element wires, for example.

The outer shield layer 33 may be composed solely of a single layer, or may be composed of a plurality of layers. In a case where the outer shield layer 33 has a plurality of layers, for example, the outer shield layer 33 may have a first outer shield layer in which a conductive tape is spirally wound along the longitudinal direction of the core 300, and a second outer shield layer in which metal element wires are longitudinally lapped or braided.

### (4) Wrapping Tape

The multi-core cable 30 may also have a wrapping tape 32 covering the outer surface of the core 300.

In a case where the multi-core cable 30 has the wrapping tape 32, the plurality of sheathed electric wires of the multi-core cable 30 may be stably arranged and bundled.

A resin tape may be used as the wrapping tape 32, for example.

The resin used for the resin tape may be one or more kinds of resins selected from fluororesins such as a polytetrafluoroethylene (PTFE) resin or the like, polyester resins such as a polyethylene terephthalate (PET) resin or the like, polyethylene (PE), or the like, which exhibit excellent heat resistance, excellent abrasion resistance, or the like.

The resin tape used as the wrapping tape 32 may include a conductive material, such as carbon or the like, so that the resin tape has conductivity. The conductive material is preferably added to the resin forming the resin tape so as to be dispersed therein. Alternatively, a metal tape obtained by disposing a copper foil or an aluminum foil on the surface of the resin tape may be used as the wrapping tape 32.

The winding direction of the wrapping tape 32 may be the same direction as the twisting direction of the sheathed electric wires composing the core 300 or may be a direction opposite to the twisting direction. A metal tape having a copper foil, an aluminum foil, or the like may be used as the wrapping tape 32, in place of the resin tape.

Because the multi-core cable 30 has the wrapping tape 32, it is possible to prevent the insulator or the like of the sheathed electric wires composing the core 300 from becoming damaged when disposing the outer shield layer 33 outside the core 300.

### (5) Inclusion

The multi-core cable 30 may also have an inclusion 31. The inclusion 31 may be disposed in a gap surrounded by the sheathed electric wires such as the coaxial cables 10 or the like. Although FIG. 3 illustrates an example in which the inclusion 31 is disposed at the center surrounded by the coaxial cables 10 in the cross section perpendicular to the longitudinal direction of the multi-core cable 30, the inclusion 31 may be disposed at an arbitrary position and is not limited to such a center position. Although the inclusion 31 is illustrated as having a shape close to a circle in FIG. 3, the inclusion 31 may be formed in a shape corresponding to the gap in which the inclusion 31 is disposed, and the shape of the inclusion 31 is not limited to the shape illustrated in FIG. 3.

The inclusion 31 may include fibers, such as staple yarns, nylon yarns, or the like. The inclusion 31 may also include high tensile fibers having a high tensile strength.

Because the multi-core cable 30 has the inclusion 31, workability can be improved when the core 300 and the multi-core cable 30 are manufactured by twisting the sheathed electric wires together. In addition, because the multi-core cable 30 has the inclusion 31, the outer shape of the core 300 or the multi-core cable 30 in the cross section perpendicular to the longitudinal direction can easily be made to an approximately circular shape, and handleability of the multi-core cable 30 can be improved.

### Exemplary Implementations

Next, specific exemplary implementations will be described, but the present invention is not limited to these exemplary implementations.

### (Evaluation Method)

First, a method for evaluating coaxial cables manufactured in the following experimental examples will be described.

### (1) Outer Diameter D11 of Central Conductor

The outer diameters D11 of the central conductors 11 of the coaxial cables 10 were measured using a micrometer according to the method prescribed under JIS C 3005 (2014).

Specifically, in an arbitrary cross section perpendicular to the longitudinal direction of the coaxial cable 10, lengths of two mutually perpendicular diameters were measured for the central conductor 11, and an average value of the two measured lengths was defined as the outer diameter D11 of the central conductor 11.

### (2) Twist Pitch of Conductor Element Wires of Central Conductor

The twist pitch of the conductor element wires 111 of the central conductor 11 was measured by a method prescribed under JIS C 3005 (2014). A ratio (P/D11) of the twist pitch P with respect to the outer diameter D11 of the central conductor 11 was calculated.

### (3) Suck-Out

An attenuation per unit length of the coaxial cable 10 was measured and calculated using a network analyzer.

The evaluation result was labeled as “A” in a case where no suck-out was observed in a frequency band of 20 GHz or lower, and the evaluation result was labeled “B” in a case where suck-out was observed in the frequency band of 20 GHz or lower.

The coaxial cable having the evaluation result “A” can be evaluated as a coaxial cable in which the generation of the suck-out is reduced. On the other hand, the coaxial cable having the evaluation result “B” may be evaluated as a coaxial cable in which the generation of the suck-out is not be reduced.

### (Experimental Conditions and Results)

The coaxial cables according to each of the following experimental examples will be described below.

Coaxial cables of the following experimental examples Exp-1, Exp-2, Exp-3, and Exp-4 were manufactured. The experimental example Exp-1 is a comparative example, and the experimental examples Exp-2, Exp-3, and Exp-4 are exemplary implementations.

### Experimental Example Exp-1

As illustrated in FIG. 1, the coaxial cable 10 having the central conductor 11, the insulator 12 disposed outside the central conductor 11, the shield layer 13 disposed outside the insulator 12, and the jacket 14 disposed outside the shield layer 13 in the cross section perpendicular to the longitudinal direction was manufactured.

The central conductor 11 was a stranded conductor having seven conductor element wires 111 twisted together, where the conductor element wires 111 were silver-plated annealed copper wires having an outer diameter illustrated in Table 1. Table 1 illustrates the evaluation results of the outer diameter D11 of the central conductor 11 and the twist pitch P of the conductor element wires 111 for the experimental example Exp-1.

The insulator 12, the shield layer 13, and the jacket 14 were configured as illustrated in Table 1.

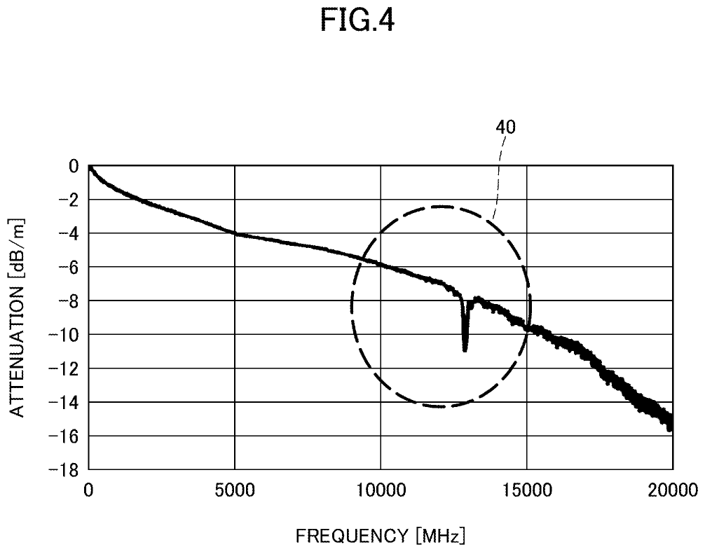

FIG. 4 illustrates the evaluation result of the attenuation of the coaxial cable of the experimental example Exp-1. In FIG. 4, the ordinate indicates the attenuation [dB/m], and the abscissa indicates the frequency [MHz]. As illustrated in FIG. 4, a suck-out 40 was observed.

### Experimental Examples Exp-2 and Exp-3

The coaxial cables 10 were manufactured and evaluated under the same conditions as in the experimental example Exp-1, except that the twist pitch P of the conductor element wires 111 was changed to the values illustrated in Table 1 when manufacturing the central conductors 11.

The evaluation results of the experimental examples Exp-2 and Exp-3 are illustrated in Table 1.

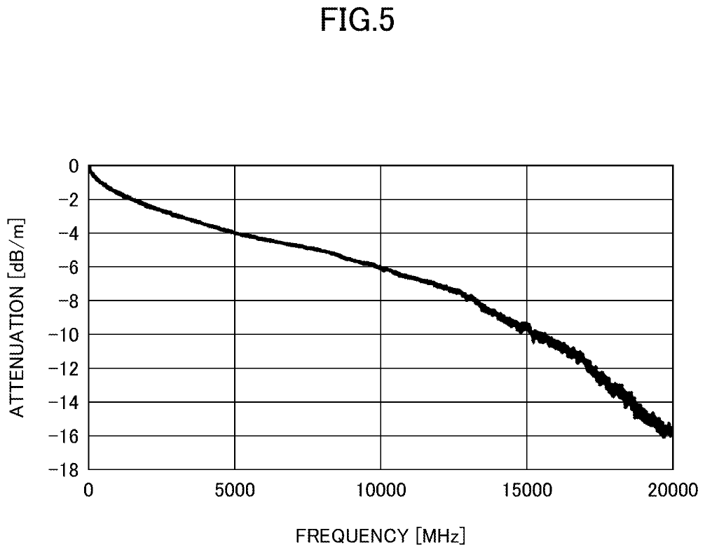

FIG. 5 illustrates the evaluation result of the attenuation of the coaxial cable of the experimental example Exp-2. In FIG. 5, the ordinate indicates the attenuation [dB/m], and the abscissa indicates the frequency [MHz].

### Experimental Example Exp-4

When the central conductor 11 was manufactured, the conductor element wires 111 having the outer diameter illustrated in Table 1 were used, and the twist pitch P of the conductor element wires 111 was changed to the value illustrated in Table 1. The coaxial cable 10 was manufactured and evaluated under the same conditions as in the experimental example Exp-1, except for the above points.

The evaluation results of the experimental example Exp-4 are illustrated in Table 1.

As illustrated in Table 1, the evaluation result was “A” for each of the experimental examples Exp-2, Exp-3, and Exp-4. In contrast, the evaluation result was “B” for the experimental example Exp-1.

TABLE 1

| | | | Exp-1 | Exp-2 | Exp-3 | Exp-4 |
|---|---|---|---|---|---|---|
| Config- | Central | Outer dimeter (mm) of | 0.102 | 0.102 | 0.102 | 0.085 |
| uration | conductor | conductor element wire | | | | |
| | | Outer diameter D11 (mm) of | 0.31 | 0.31 | 0.31 | 0.26 |
| | | central conductor | | | | |
| | | Twist pitch P (mm) of | 4.2 | 2.1 | 2.5 | 2.5 |
| | | conductor element wire | | | | |
| | | P/D11 | 13.5 | 6.8 | 8.1 | 9.62 |

| Insulator | Material | | FEP |
|---|---|---|---|
| Shield | First shield | Type of metal wire | Tin-plated annealed copper wire |
| layer | layer | Structure | Longitudinal lapping |

| | | |
|---|---|---|
| | Second shield layer | Copper tape |
| Jacket | Material | PET |

| | | | | | |
|---|---|---|---|---|---|
| Evaluation | Suck-out | B | A | A | A |

According to one aspect of the present disclosure, it is possible to provide a coaxial cable which can reduce the suck-out.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A coaxial cable comprising:
a central conductor including a plurality of twisted conductor element wires;
an insulator disposed outside the central conductor;
a shield layer disposed outside the insulator; and
a jacket disposed outside the shield layer, wherein
the shield layer includes a first shield layer and a second shield layer in an order from a position closest to the central conductor,
the first shield layer includes a plurality of longitudinally lapped metal wires,
the second shield layer includes a metal tape disposed outside the first shield layer,
an outer diameter of the central conductor is 0.2 mm or more and 0.4 mm or less, and
a twist pitch of the conductor element wires of the central conductor is 6 times or more and 10 times or less the outer diameter of the central conductor.

2. A multi-core cable comprising:
a core including a plurality of sheathed electric wires including the coaxial cable according to claim 1; and
an outer sheath disposed outside the core.
